(19) United States
(12) Patent Application Publication
(10) Pub. No.: US 2026/0009241 A1
(43) Pub. Date: Jan. 8, 2026

(54) DEVICE FOR FORMING/STRIPPING PROPS FOR CASTINGS OF CONCRETE FLOOR SLABS

(71) Applicant: FARESIN FORMWORK S.P.A., Breganze (IT)

(72) Inventors: Chiara FARESIN, Breganze (IT); Lucia FARESIN, Bassano Del Grappa (IT)

(73) Assignee: FARESIN FORMWORK S.P.A., Breganze (IT)

(21) Appl. No.: 18/993,344

(22) PCT Filed: Jul. 10, 2023
(86) PCT No.: PCT/IB2023/057053

§ 371 Date: Jan. 10, 2025

(30) Foreign Application Priority Data
Jul. 12, 2022 (IT) 102022000014599

(51) Int. Cl. E04G 11/48; E04G 25/06

(52) U.S. Cl. CPC E04G 11/486; E04G 25/068

(57) ABSTRACT

A device for forming/stripping props for castings of concrete floor slabs, which comprises, along its axis of extension, in the following order:

a first plate, which is annular and fixed with respect to the axis of extension, and which has a plurality of first protrusions which are directed toward a second plate that can rotate and/or translate on a plane that is perpendicular to the axis of extension and is substantially parallel to the first plate, and plurality of second protrusions which are directed toward the first plate, the second plate having a plurality of third protrusions which are directed toward a third plate, the third plate being annular and fixed with respect to the axis of extension and being substantially parallel to the first plate, and having a plurality of fourth protrusions which are directed toward the second plate.

The present invention relates to a device for forming/stripping props for castings of concrete floor slabs.

Nowadays, for castings of concrete floor slabs, formwork units are used which are supported by beams that rest on a plurality of props.

The prop is a telescopic device, used in a vertical configuration, which comprises an external first tubular body, within which a second tubular body can slide, which ends in a plate for connecting to a beam and/or formwork.

The first tubular body has an external threading at its upper end, and two opposing and parallel slots that extend longitudinally along this threading.

The second tubular body has two opposing and parallel rows of through holes along its direction of extension, each one of which is adapted to correspond to a respective slot in the first tubular body, for inserting a transverse pin for locking the overall length of the prop to the desired size.

During use the prop is formed to support the formwork.

To do this, a ring nut is screwed onto the threading of the first body in order to clamp the second tubular body to the first, at the desired length, by virtue of the interference between the ring nut and the pin. The pin passes through the slots of the first tubular body and two opposite holes of the second tubular body, and it interferes in turn with the upper edge of the slots of the first tubular body and the edges of the corresponding holes of the second tubular body.

After the casting of the concrete, and once the concrete has hardened, the prop is stripped, so that it can be removed, by unscrewing the ring nut in order to lower the second tubular body by sliding it inside the first.

Such known art has a number of drawbacks.

In fact, after casting the liquid concrete, which does not yet have any supporting capacity, the props bear all the weight of the mass of concrete, transmitting it to the ground.

After a few days the concrete is sufficiently hardened (although not completely) and the props can be stripped and removed. At the same time, however, the concrete is not yet completely hardened and rigid, and the props therefore remain trapped and compressed between two successive floor slabs.

So in order to be able to strip and remove the props, it is necessary to act on the ring nut, by striking it with a hammer and with a force of greater or lesser extent, depending on the compression to which the prop is subjected.

This results in an operation to strip the prop that is complex, difficult and inconvenient.

Furthermore, with the passage of time, the hammer blows on the ring nut and the compression of the prop during stripping result in a deterioration thereof, shortening its operating life drastically.

The aim of the present invention is to provide a device for forming/stripping props for castings of concrete floor slabs that is capable of improving the known art in one or more of the abovementioned aspects.

Within this aim, an object of the invention is to provide a device for forming/stripping props for castings of concrete floor slabs that makes an operation to form/strip the props easier, faster and less difficult than similar, conventional devices.

Another object of the invention is to provide a device for forming/stripping props for castings of concrete floor slabs that offers, also for the prop to which it is applied, a longer operating life than similar, conventional devices and props.

A further object of the present invention is to overcome the drawbacks of the known art in a manner alternative to any existing solutions.

Another object of the invention is to provide a device for forming/stripping props for castings of concrete floor slabs that is highly reliable, easy to implement and low-cost.

This aim and these and other objects which will become more apparent hereinafter are achieved by a device for forming/stripping props for castings of concrete floor slabs, characterized in that it comprises, along its axis of extension, in the following order:
a first plate, which is annular and fixed with respect to said axis of extension, and which has a plurality of first protrusions which are directed toward a second plate,
said second plate, which can rotate and/or translate on a plane that is perpendicular to said axis of extension and is substantially parallel to said first plate, and which has a plurality of second protrusions which are directed toward said first plate and are shaped at least partially complementarily to said first protrusions, said second plate having a plurality of third protrusions which are directed toward a third plate,
said third plate, which is annular and fixed with respect to said axis of extension and is substantially parallel to said first plate, and which has a plurality of fourth protrusions which are directed toward said second plate and are shaped at least partially complementarily to said third protrusions.

Further characteristics and advantages of the invention will become more apparent from the detailed description that follows of a preferred, but not exclusive, embodiment of the device for forming/stripping props for castings of concrete floor slabs according to the invention, which is illustrated for the purposes of non-limiting example in the accompanying drawings wherein:

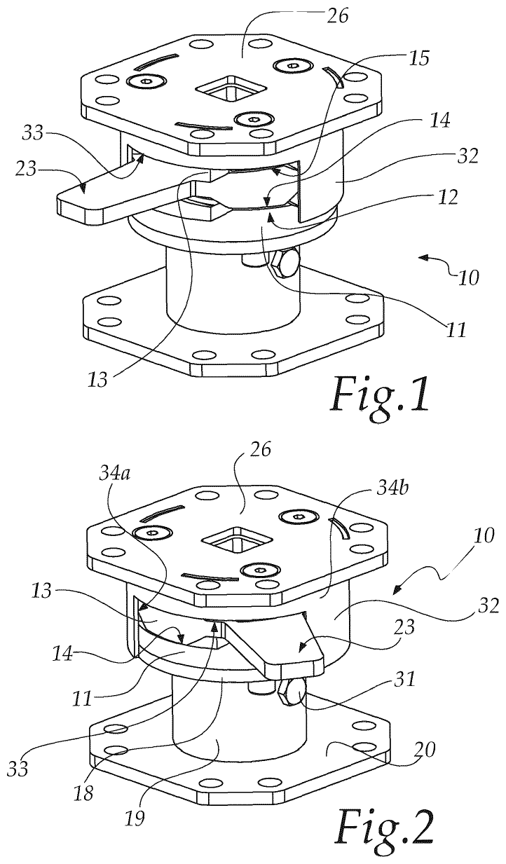

FIG. 1 is an overall perspective view of a device for forming/stripping props for castings of concrete floor slabs, according to the invention, in the forming configuration;

FIG. 2 is an overall perspective view of the device for forming/stripping props for castings of concrete floor slabs of FIG. 1, in the stripping configuration;

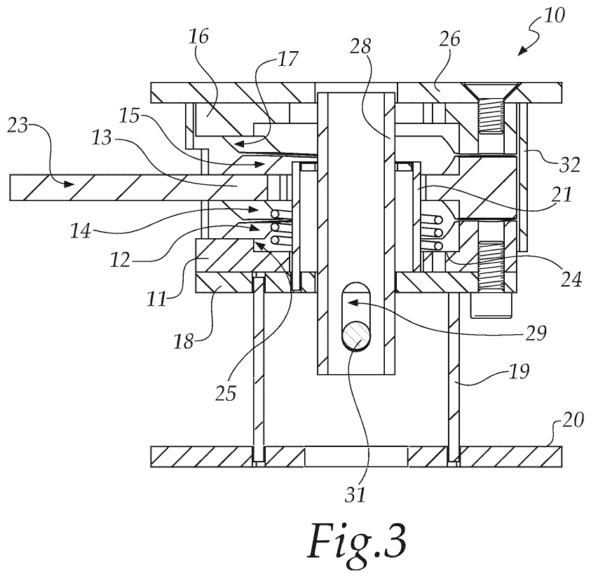

FIG. 3 is a cross-sectional side view of the device for forming/stripping props for castings of concrete floor slabs of FIG. 1, in the same configuration as that figure;

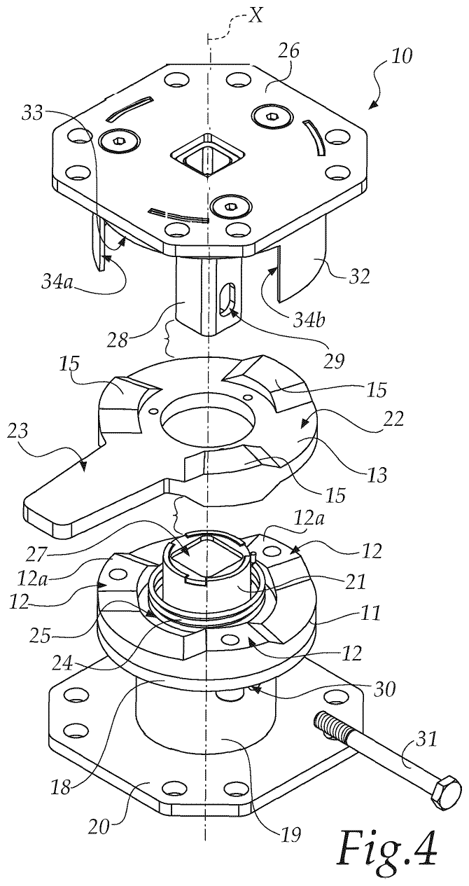

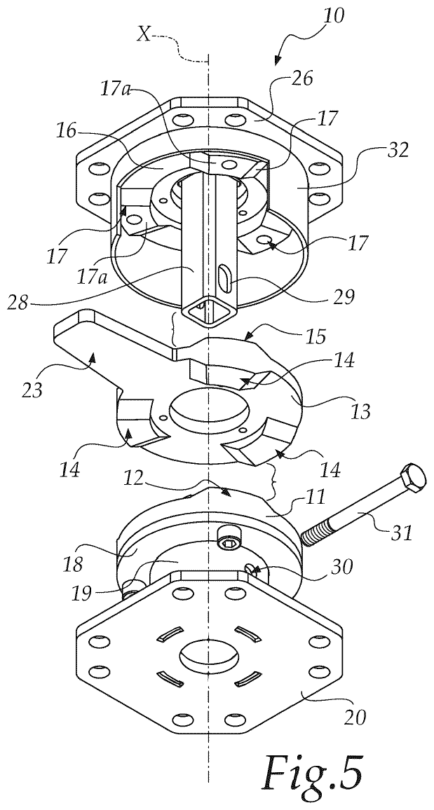

FIGS. 4 and 5 are two different exploded views of the device for forming/stripping props for castings of concrete floor slabs of FIG. 1;

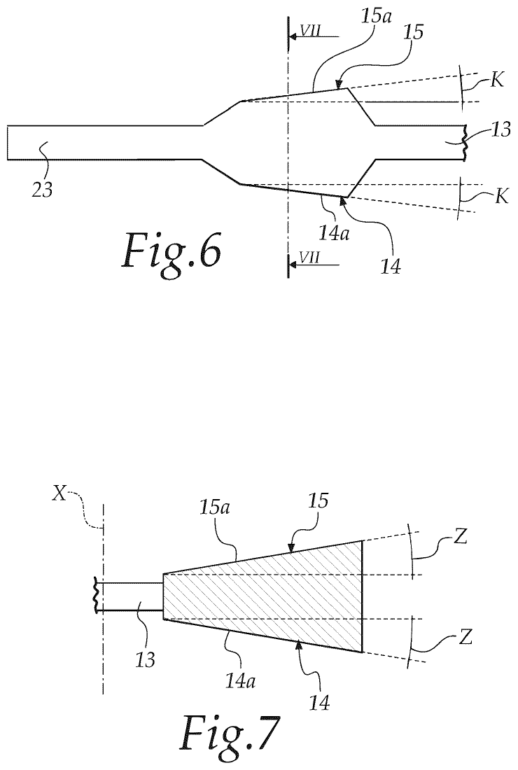

FIG. 6 is a partial side view of a component of the device of FIG. 1;

FIG. 7 is a cross-sectional partial view of the component of FIG. 6, taken along the line VII-VII of FIG. 6.

With reference to the figures, a device for forming/stripping props for castings of concrete floor slabs, according to the invention, is generally designated by the reference numeral 10.

The device 10 comprises, along its axis of extension X, in the following order:
a first plate 11, which is annular and fixed with respect to the axis of extension X, and which has a plurality of first protrusions 12 which are directed toward a second plate 13,
the second plate 13, which can rotate about the axis of extension X and is parallel to the first plate 11, has a plurality of second protrusions 14 directed toward the first plate 11 and shaped at least partially complementarily to the first protrusions 12, and has a plurality of third protrusions 15 which are directed toward a third plate 16,
the third plate 16, which is annular and fixed with respect to the axis of extension X and is substantially parallel to the first plate 11, has a plurality of fourth protrusions 17 directed toward the second plate 13 and shaped at least partially complementarily to the third protrusions 15.

In variations of embodiment, not shown in the figures, the second plate 13 can rotate and/or translate on a plane perpendicular to the axis of extension X.

Advantageously, the second plate 13 has:
a portion 22 with a substantially annular contour, at the region comprising the second protrusions 14 and the third protrusions 15,
a handle 23, which extends radially from the portion 22, in a single piece therewith.

In particular, the first plate 11 is integral with a flange 18, which extends at the upper end of a first tubular body 19 which has, at its lower end, a base 20 for resting on the ground.

In the present description, the expressions “upper”, “lower” etc. refer to the configuration for use of the device 10.

The first tubular body 19 has an axis of extension that coincides with the axis of extension X of the device 10.

A second tubular body 21 extends from the flange 18 and has a diameter that is smaller than the diameter of the first tubular body 19 and is coaxial thereto.

The second tubular body 21 extends from the surface of the flange 18 that is opposite from the one directed toward the first tubular body 19.

The second tubular body 21 passes through the first plate 11 and the second plate 13.

The device 10 comprises means 24 for the automatic forming of the device 10.

These means 24 for the automatic forming of the device 10 comprise a helical spring, which is:
arranged inside the hole 25 of the first plate 11 and surrounding the second tubular body 21,
interposed between the flange 18 and the second plate 13.

The second tubular body 21 has an inlet 27 with a square internal profile.

The third plate 16 is integral with a flat bracket 26 for anchoring to a prop, not shown in the figures.

The bracket 26 is arranged at the end of the device 10 that is opposite with respect to the base 20.

A third tubular body 28 extends from the bracket 26, and has a square cross-section shaped complementarily to the inlet 27 of the second tubular body 21 in which it is inserted.

The third tubular body 28 passes through, in the following order:
the third plate 16,
the second tubular body 21,
the flange 18,
at least partially the first tubular body 19.

The third tubular body 28 has two parallel slots 29 (of which only one is visible in the figures), which correspond to two through holes 30 in the first tubular body 19 (of which only one is visible in the figures).

In particular, these through holes 30 are interposed between the base 20 and the flange 18.

A pin/screw 31 of a bolt is inserted into these slots 29 and into these through holes 30.

The pin/screw 31 is designed to prevent the extraction and the separation of the third plate 16 from the second plate 13 and from the first plate 11.

Specifically, the slots 29 allow the third tubular body 28 to slide during forming/stripping, but by virtue of the presence of the pin/screw 31, which passes through it and also passes through the through holes 30, the third tubular body 28 does not come out of the first tubular body 19.

An inverted cup-shaped body 32 extends from the bracket 26 in the direction of the first tubular body 19 and with the same axis of extension X.

This inverted cup-shaped body 32 has a diameter that is larger than the diameter of the first tubular body 19 and is in a single piece with the bracket 26 that corresponds to the bottom of the cup.

The inverted cup-shaped body 32 has a lateral opening 33 for the handle 23 to slide during forming/stripping.

The lateral ends 34a, 34b of the opening 33 define the sliding limits of the handle 23.

In particular, the second protrusions 14 and the third protrusions 15 each have a surface 14a, 15a for contact respectively with the first plate 11 and with the third plate 16 in the forming configuration, which have an angle k of circumferential inclination, of around 2°, with respect to a plane that is parallel to the plane of arrangement of the handle 23.

This inclination favors the stripping of the device.

Furthermore, in a variation of embodiment, shown in FIG. 7, the second protrusions 14 and the third protrusions 15 each have a surface 14a, 15a for contact respectively with the first plate 11 and with the third plate 16 in the forming configuration, which have an angle z of radial inclination with respect to a plane that is parallel to the plane of arrangement of the handle 23.

This inclination favors the rotation of the second plate 13.

The use of the device 10 according to the invention is the following.

The device 10 is:
fixed to a prop, not shown in the figures, at its bracket 26,
placed on the ground at its base 20.

In the forming configuration, illustrated in FIGS. 1, 3 and 6:
the second protrusions 14 of the second plate 13 are arranged at the first protrusions 12 of the first plate 11,
the third protrusions 15 of the second plate 13 are arranged at the fourth protrusions 17 of the third plate 16.

To strip the device 10 and be able to remove the prop from below the casting of the floor slab in concrete, it is sufficient to rotate the second plate 13, by acting on the handle 23, so as to bring each one of the second protrusions 14 between two successive first protrusions 12, and each one of the third protrusions 15 between two successive fourth protrusions 17.

In this manner, the third plate 16 approaches the first plate 11 and this generates sufficient space to remove the prop from below the concrete casting.

Once the prop is removed from the concrete casting, the device 10 is automatically reformed by virtue of the elastic return of the spring 24, which pushes the second plate 13 in the direction of the third plate 16, returning:
the second protrusions 14 to/above the first protrusions 12,
the third protrusions 15 to/below the fourth protrusions 17.

Reforming can also occur when the prop, to which the device is applied, is associated with a structure with multiple props and is shortened, by translating the (telescopic) lower part of the prop, while the upper part is still in contact with the casting.

In such case, the reforming occurs as soon as a free space opens up between the (lower) first plate 11 and the second plate 13.

In practice it has been found that the invention fully achieves the intended aim and objects by providing a device for forming/stripping props for castings of concrete floor slabs that makes an operation to form/strip the props easier, faster and less difficult than similar conventional devices.

With the invention a device for forming/stripping props for castings of concrete floor slabs has been provided that offers, also for the prop to which it is applied, a longer operating life than similar conventional devices and props.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102022000014599 from which this application claims priority are incorporated herein by reference.

1-12. (canceled)

13. A device for forming/stripping props for castings of concrete floor slabs, comprising, along an axis of extension thereof, in the following order:
a first plate, which is annular and fixed with respect to said axis of extension, and which has a plurality of first protrusions; a second plate, said first protrusions being directed toward said second plate e,
said second plate being configured to rotate and/or translate on a plane that is perpendicular to said axis of extension and being substantially parallel to said first plate, said second plate having a plurality of second protrusions which are directed toward said first plate and are shaped at least partially complementarily to said first protrusions, said second plate having a plurality of third protrusions,
a third plate, said third protrusions being directed toward said third plate,
said third plate being annular and fixed with respect to said axis of extension and being substantially parallel to said first plate, said third plate having a plurality of fourth protrusions which are directed toward said second plate and are shaped at least partially complementarily to said third protrusions.

14. The device according to claim 13, wherein said second plate has:
a portion with a substantially annular contour, at the region comprising said second protrusions and said third protrusions,
a handle, which extends radially from said portion, in a single piece therewith.

15. The device according to claim 13, wherein said first plate is integral with a flange, which extends at the upper end of a first tubular body, said first tubular body having at a lower end thereof a ground resting base, said first tubular body having an axis of extension that coincides with said axis of extension (X) of said device (10).

16. The device according to claim 15, wherein a second tubular body extends from said flange and has a diameter that is smaller than the diameter of said first tubular body and is coaxial thereto, said second tubular body extending from the surface of said flange that is opposite to the one directed toward said first tubular body, said second tubular body passing through said first plate and said second plate.

17. The device according to claim 13, further comprising means for the automatic forming of said device.

18. The device according to claim 17, wherein said means for the automatic forming of said device comprise a helical spring, said helical spring being:
arranged inside the hole of said first plate and surrounding said second tubular body,
interposed between said flange and said second plate.

19. The device according to claim 15, wherein said third plate is integral with a flat bracket, said flat bracket being arranged at an end of said device that is opposite with respect to said ground resting base.

20. The device according to claim 19, wherein a third tubular body extends from said flat bracket, and has a square cross-section shaped complementarily to an inlet of said second tubular body in which the third tubular body is inserted, said third tubular body passing through, in the following order:
said third plate,
said second tubular body,
said flange,
at least partially said first tubular body.

21. The device according to claim 20, wherein said third tubular body is provided with two parallel slots, which correspond to two through holes of said first tubular body, said through holes being interposed between said base and said flange, a pin/screw of a bolt being inserted into said slots and into said through holes.

22. The device according to claim 19, wherein an inverted cup-shaped body extends from said flat bracket in a direction of said first tubular body and with said axis of extension, said inverted cup-shaped body having a diameter that is larger than a diameter of said first tubular body and being in a single piece with said flat bracket corresponding to the bottom of said cup, said inverted cup-shaped body having a lateral opening for said handle to slide during forming/stripping, t lateral ends of said opening defining sliding limits of said handle.

23. The device according to claim 14, wherein said second protrusions and said third protrusions each have a surface for contact respectively with said first plate and with said third plate in a forming configuration, which have an angle of circumferential inclination with respect to a plane that is parallel to a plane of arrangement of said handle.

24. The device according to claim 14, wherein said second protrusions and said third protrusions each have a surface for contact respectively with said first plate and with said third plate in a forming configuration, which have an angle of radial inclination with respect to a plane that is parallel to a plane of arrangement of said handle.
